(19) United States
(12) Patent Application Publication
(10) Pub. No.: US 2010/0147169 A1
(43) Pub. Date: Jun. 17, 2010

(54) FOLDER SUPERSTRUCTURE OF A WEB-FED PRINTING PRESS

(75) Inventor: Manfred BRETTEL, Untermeitingen (DE)

Correspondence Address: CROWELL & MORING LLP;INTELLECTUAL PROPERTY GROUP, P.O. BOX 14300, WASHINGTON, DC, 20044-4300, US

(73) Assignee: manroland AG, Offenbach/Main (DE)

(21) Appl. No.: 12/639,799

(22) Filed: Dec. 16, 2009

(30) Foreign Application Priority Data
Dec. 17, 2008 (DE) 10 2008 054 831.6

(51) Int. Cl. B41F 13/56

(52) U.S. Cl. 101/227

(57) ABSTRACT

A folder superstructure of a web-fed printing press is disclosed. The folder superstructure having several formers positioned side by side, namely at least four formers positioned side by side laterally, where three formers are positioned such that a center former of these three formers is positioned in the center of the machine or in the center of undivided print substrate webs and the two outer formers of these three formers are positioned symmetrically to the center former. Partial webs of the print substrate webs separated by longitudinal cutting can be guided over each of these three formers with and/or without prior turning, and at least one further former is positioned laterally next to these three formers, over which partial webs of print substrate webs separated by longitudinal cutting can be guided exclusively with prior turning.

This application claims the priority of German Patent Document No. 10 2008 054 831.6, filed Dec. 17, 2008, the disclosure of which is expressly incorporated by reference herein.

### BACKGROUND AND SUMMARY OF THE INVENTION

The invention relates to a folder superstructure of a web-fed printing press.

A web-fed printing press has a reel splicer, a printing unit, a folder superstructure and a folding unit downstream from the folder superstructure, wherein the folder superstructure typically includes several formers.

Thus, a folder superstructure of a web-fed printing press is known from German Patent Document No. DE 10 2005 042 345 Al, which includes three formers positioned side by side, wherein the two outer formers can be displaced laterally and thus transverse to a former inclination of the same, namely symmetrically to the center of the machine. The folder superstructure can thereby be adapted to different web widths.

The objective of the invention is creating a novel folder superstructure with expanded production possibilities. The folder superstructure comprises at least four formers positioned side by side laterally, wherein three formers are positioned such that a center former of these three formers is positioned in the center of the machine or in the center of undivided print substrate webs and the two outer formers of these three formers are positioned symmetrically to the center former, wherein partial webs separated by longitudinal cutting of the print substrate webs can be guided over each of these three formers with and/or without prior turning, and wherein at least one further former is positioned laterally next to these three formers, over which partial webs of print substrate webs separated by longitudinal cutting can be guided exclusively with prior turning.

According to an advantageous further development of the invention, the two outer formers of the three formers positioned directly side by side can be swiveled, namely between a production position and a rest position, wherein at the time when the two outer formers of these three formers are swiveled into the production position, the folder superstructure with these three formers and a fourth former are used for a 4-book production, for which partial webs produced by trisecting the print substrate webs can be guided over the formers, and wherein at the time when the two outer formers of these three formers are swiveled into the rest position, the folder superstructure with these three formers and the fourth former are used for a 2-book production, for which partial webs produced by bisecting the print substrate webs can be guided over the center former of these three formers and the fourth former.

Preferred further developments of the invention are disclosed in the following description. Without being limited hereto, one exemplary embodiment of the invention is explained in greater detail on the basis of the drawings.

### BRIEF DESCRIPTION OF THE DRAWINGS

FIG. 1 is a schematic representation of an inventive folder superstructure in a first state;

FIG. 2 is a schematic representation of the inventive folder superstructure in a second state; and

FIG. 3 is a side view of the representation of FIG. 2.

### DETAILED DESCRIPTION OF THE DRAWINGS

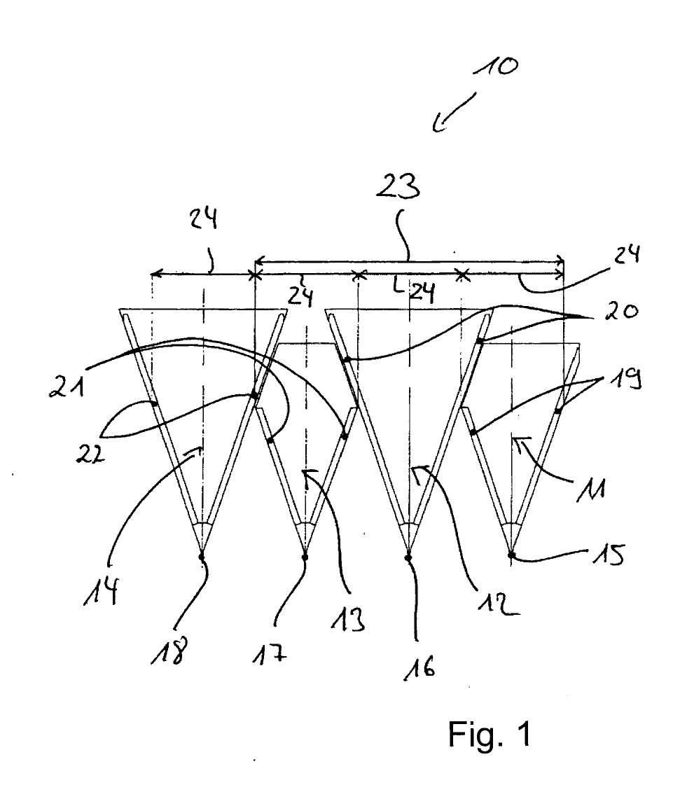

FIGS. 1 through 3 depict different views of an inventive folder superstructure 10 of a web-fed printing press, wherein the inventive folder superstructure 10 comprises at least four formers positioned side by side laterally, and in the depicted exemplary embodiment four formers 11, 12, 13 and 14 positioned side by side laterally. The four formers 11, 12, 13 and 14 of the inventive folder superstructure 10 are all positioned side by side laterally in a row.

Three of these four formers, namely formers 11, 12 and 13 positioned directly side by side, are positioned such that center former 12 of these three formers 11, 12 and 13 is in the center of the machine or in the center of printed, undivided print substrate webs. In FIG. 1 the double arrow 23 indicates the width of printed, undivided as well as unturned print substrate webs, wherein FIG. 1 directly shows that the center former 12 is positioned in the center of these print substrate webs.

The two outer formers 11 and 13 of these three formers 11, 12 and 13 positioned directly side by side are positioned symmetrically to the center former 12 of these three formers 11, 12 and 13, wherein partial webs produced by longitudinal cutting of print substrate webs can be guided over each of these three formers 11, 12 and 13 positioned directly side by side without prior turning of the same. Thus, it is possible with the folder superstructure 10 in FIG. 1 to trisect a printed and undivided print substrate web (indicated by arrow 23) by longitudinal cutting, wherein then the partial webs produced in the process can be guided without turning the same over the three formers 11, 12 and 13. In FIG. 1 the width of the partial webs produced by trisecting the print substrate webs is indicated by double arrow 24.

Reference is made to the fact that turned partial webs may also be guided to each of the three formers 11, 12 and 13 positioned directly side by side.

In addition to the three formers 11, 12 and 13 over which the partial webs can be guided with and/or without prior turning, the inventive folder superstructure 10 also has the fourth former 14, which is positioned laterally next to the three formers 11, 12 and 13 in a row with the same, wherein partial webs separated by longitudinal cutting can be guided over this fourth former 14 exclusively with prior turning.

As FIG. 1 shows each former 11, 12, 13 and 14 of the inventive folder superstructure 10 has a former nose 15, 16, 17 or 18 as well as former edges 19, 20, 21 or 22, wherein the extension of the former edges 19, 20, 21 and 22 determines the former width of the formers 11, 12, 13 and 14.

FIG. 1 shows that center former 12 of the three formers 11, 12 and 13, over which the partial webs can be guided with and/or without prior turning, features a greater former width than the two outer formers 11, 13 of these three formers 11, 12 and 13. The fourth former 14 positioned next to these three formers 11, 12 and 13, over which partial webs can be guided exclusively with prior turning, features the former width of the center former 12 of the three formers 11, 12 and 13 positioned directly side by side.

Such partial webs whose width corresponds to a maximum of one third of the maximum width of a printed print substrate web can be guided over the two outer formers 11, 13 of the three formers 11, 12 and 13, over which the partial webs can be guided with and/or without prior turning. Wider partial webs may also be guided over the center former 12 of the three formers 11, 12 and 13 as well as over the fourth former 14.

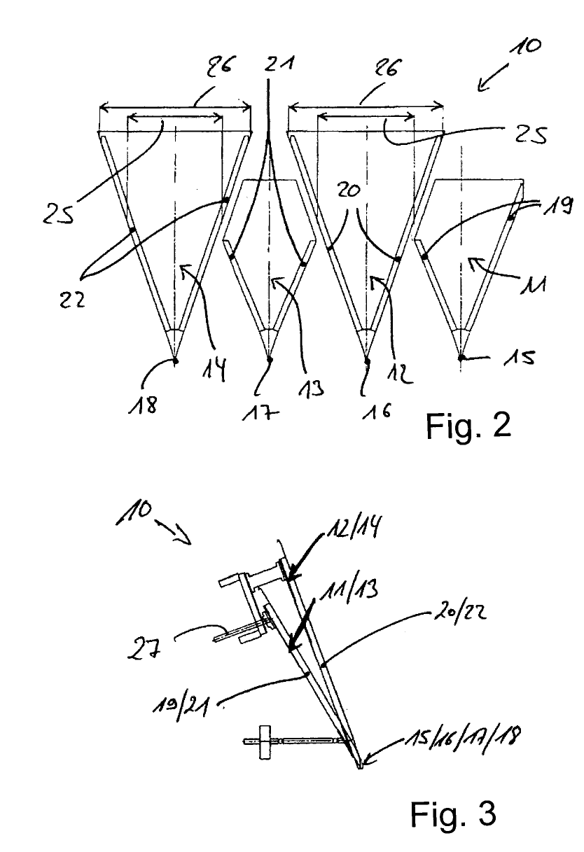

The two outer formers 11 and 13 of the three formers 11, 12 and 13, over which partial webs can be guided with and/or without prior turning, can be swiveled between two positions, namely between the production position of the formers depicted in FIG. 1 and the rest position of the formers depicted in FIGS. 2 and 3. When swiveling the formers 11 and 13 between the production position and the rest position, the position of the former noses 15 and 17 of the formers remains approximately unchanged.

At the time when the two outer formers 11, 13 of the three formers 11, 12 and 13, over which the unturned partial webs can be guided with and/or without prior turning, are swiveled into the production position in FIG. 1, the folder superstructure 10 with its then four formers 11, 12, 13 and 14 in the production position is used to produce a 4-book product and therefore to carry out a 4-book production, for which partial webs produced by trisecting the print substrate webs can be guided over all four formers 11, 12, 13 and 14.

At the time when the two outer formers 11, 13 of the three formers 11, 12 and 13, over which the unturned partial webs can be guided with and/or without prior turning, are swiveled into the rest position (see FIG. 2), the folder superstructure 10, in which then only the formers 12 and 14 are in a production position, is used to produce a 2-book product or to carry out a 2-book production, for which partial webs produced by bisecting the print substrate webs can be guided over the formers 12 and 14.

The inventive folder superstructure 10 in the state in FIG. 1 is used in particular for processing 6-page-wide print substrate webs, which at the time when the folder superstructure 10 assumes the state in FIG. 1, are being cut longitudinally symmetrically into three partial webs, each of which is 2 pages wide. These 2-page-wide partial webs of longitudinally cut print substrate webs can then be guided at will over all four formers 11, 12, 13 and 14 with and/or without turning the partial webs to produce a printed product with four books. A turning of partial webs is mandatory exclusively in the area of the former 14 in order to guide the partial webs to the former 14.

At the time when the folder superstructure 10 assumes the state in FIG. 2, the folder superstructure is used to process 4-page-wide print substrate webs, which are then bisected, wherein then 2-page-wide partial webs can be guided over the wider formers 12 and 14 in order to produce a printed product with two books.

At the time when the inventive folder superstructure 10 assumes the state in FIG. 1, the folder superstructure is used in particular for producing a printed newspaper product. At the time when the folder superstructure assumes the state in FIG. 2, it is used in particular to form a commercial printed product.

In FIG. 2 double arrow 25 shows the minimum width of partial webs that can be processed by the formers 12 and 14 and double arrow 26 shows the maximum width of partial webs that can be processed by the same.

As FIG. 3 in particular shows, an actuating element 27 is assigned to an upper section of the swivelable or foldable formers 11, 13, and this actuating element can be used to swivel the formers 11, 13 between the production position and the rest position. As stated above, the position of the former noses 15 and 17 of the formers 11 and 13 remains approximately unchanged.

The inventive folder superstructure 10 makes it possible to produce a great variety of products and provide a variability of formats without the formers 11, 12, 13 and 14 of the same being laterally displaceable. Only the formers 11 and 13 with the smaller former width are designed to be swivelable or foldable in order to convey the same between a production position and a rest position. At the time when the formers assume the production position, the folder superstructure 10 is used to form a printed newspaper product with four books. At the time when the formers assume the rest position, the folder superstructure is used to produce a commercial printed product with two books. Partial webs can be guided over the formers 11, 13 with the smaller former width, which features a maximum of one third of the width of a 6-page-wide web. Wider partial webs may also be guided over the folders 12 and 14.

### LIST OF REFERENCE NUMBERS

10 Folder superstructure
11 Former
12 Former
13 Former
14 Former
15 Former nose
16 Former nose
17 Former nose
18 Former nose
19 Former edge
20 Former edge
21 Former edge
22 Former edge
23 Print substrate web width
24 Partial web width
25 Partial web width
26 Partial web width
27 Actuating element

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A folder superstructure of a web-fed printing press, comprising:
at least four formers positioned side by side laterally;
wherein three of the at least four formers are positioned such that a center former of the three formers is positioned in a center of the press or in a center of undivided print substrate webs and wherein two outer formers of the three formers are positioned symmetrically to the center former;
wherein partial webs of the print substrate webs separated by longitudinal cutting are guidable over each of the three formers with and/or without prior turning;
and wherein a fourth former of the at least four formers is positioned laterally next to the three formers and wherein partial webs of print substrate webs separated by longitudinal cutting are guidable exclusively over the fourth former with prior turning.

2. The folder superstructure according to claim 1, wherein the center former of the three formers has a former width that is greater than a former width of the two outer formers of the three formers and wherein the fourth former has a former width which is a same width as the former width of the center former.

3. The folder superstructure according to claim 1, wherein the two outer formers of the three formers are swivelable between a production position and a rest position.

4. The folder superstructure according to claim 3, wherein former noses of the two outer formers do not change their position during swiveling.

5. The folder superstructure according to claim 3, wherein at a time when the two outer formers are swiveled into the production position, the folder superstructure with the three formers and the fourth former are used for a 4-book production, for which partial webs produced by trisecting the print substrate webs are guidable over all four formers.

6. The folder superstructure according to claim 5, wherein during the 4-book production, 6-page-wide print substrate webs are guidable over the four formers after being trisected to form a printed newspaper product.

7. The folder superstructure according to claim 3, wherein at a time when the two outer formers of the three formers are swiveled into the rest position, the folder superstructure with the three formers and the fourth former are used for a 2-book production, for which partial webs produced by bisecting the print substrate webs are guidable over the center former of the three formers and the fourth former.

8. The folder superstructure according to claim 7, wherein during the 2-book production, 4-page-wide print substrate webs are guidable over the center former and the fourth former after being bisected to form a commercial printed product.
